(19) United States
(12) Patent Application Publication
(10) Pub. No.: US 2023/0276859 A1
(43) Pub. Date: Sep. 7, 2023

(54) AEROSOL DELIVERY SYSTEMS

(71) Applicant: Nicoventures Trading Limited, London (GB)

(72) Inventor: Sean A. Daugherty, Yadkinville, NC (US)

(21) Appl. No.: 17/687,204

(22) Filed: Mar. 4, 2022

(51) Int. Cl. A24F 40/53; A24F 40/65; A24F 40/40

(52) U.S. Cl. CPC A24F 40/53; A24F 40/40; A24F 40/65

(57) ABSTRACT

A holder for an aerosol delivery device, the holder including: an aerosol delivery device receiving region configured to receive at least a portion of an aerosol delivery device; a controller configured to establish a data communication link with an aerosol delivery device; wherein the controller comprises a memory element configured to store user profile information for an aerosol delivery device; and wherein the controller is configured to selectively transmit user profile information from the memory element to the aerosol delivery device over the data communication link, and / or to receive user profile information from the aerosol delivery device over the data communication link and store the user profile information on the memory element.

### FIELD

The present disclosure relates to aerosol delivery systems.

### BACKGROUND

Aerosol delivery devices such as electronic cigarettes (e-cigarettes) generally contain a aerosol generating material, such as a reservoir of a source liquid, which may contain an active substance and / or a flavour, from which an aerosol or vapour is generated for inhalation by a user, for example through heat vaporisation. Thus, an aerosol delivery device will typically comprise a aerosol generation chamber containing an aerosol generator, e.g. a heating element, arranged to vaporise or aerosolise a portion of precursor material to generate a vapour or aerosol in the aerosol generation chamber. As a user inhales on the device and electrical power is supplied to the vaporiser, air is drawn into the device through an inlet hole and along an inlet air channel connecting to the aerosol generation chamber where the air mixes with vaporised precursor material to form a condensation aerosol. There is an outlet air channel connecting from the aerosol generation chamber to an outlet in the mouthpiece and the air drawn into the aerosol generation chamber as a user inhales on the mouthpiece continues along the outlet flow path to the mouthpiece outlet, carrying the aerosol with it, for inhalation by the user. Some electronic cigarettes may also include a flavour element in the air flow path through the device to impart additional flavours. Such devices may sometimes be referred to as hybrid devices, and the flavour element may, for example, include a portion of tobacco arranged in the air flow path between the aerosol generation chamber and the mouthpiece such that aerosol / condensation aerosol drawn through the device passes through the portion of tobacco before exiting the mouthpiece for user inhalation.

An aerosol delivery device may store user profile information relating to usage and control of the device by a user. An aerosol delivery device may further be configured to establish data connections with one or more further electronic devices in a wider aerosol delivery system. It is of interest to develop devices in which user profile information can be transmitted between an aerosol delivery device and further electronic devices in order to provide enhanced user functionality. Various approaches are described herein which seek to help at least some of the issues discussed above.

### SUMMARY

According to a first aspect of the disclosure, there is provided a holder for an aerosol delivery device, the holder comprising: an aerosol delivery device receiving region configured to receive at least a portion of an aerosol delivery device; a controller configured to establish a data communication link with an aerosol delivery device; wherein the controller comprises a memory element configured to store user profile information for an aerosol delivery device; and wherein the controller is configured to selectively transmit user profile information from the memory element to the aerosol delivery device over the data communication link, and / or to receive user profile information from the aerosol delivery device over the data communication link and store the user profile information on the memory element.

According to a second aspect of the disclosure, there is provided a method of operating a holder for an aerosol delivery device, the holder comprising a controller, wherein the controller is configured to perform the steps of: establishing a data communication link with an aerosol delivery device; selectively transmitting user profile information from a memory element of the controller to the aerosol delivery device over the data communication link, and / or receiving user profile information from the aerosol delivery device over the data communication link and storing the user profile information on the memory element.

According to a third aspect of the disclosure, there is provided a computer readable storage medium comprising instructions which, when executed by a processor, performs the method of the second aspect.

According to a fourth aspect of the disclosure, there are provided holder means for an aerosol delivery device, the holder means comprising: aerosol delivery device receiving means configured to receive at least a portion of an aerosol delivery device; controller means configured to establish a data communication link with an aerosol delivery device; wherein the controller means comprises memory element means configured to store user profile information for an aerosol delivery device; and wherein the controller means is configured to selectively transmit user profile information from the memory element means to the aerosol delivery device over the data communication link, and / or to receive user profile information from the aerosol delivery device over the data communication link and store the user profile information on the memory element.

According to a fifth aspect of the disclosure, there is provided an aerosol delivery device, the aerosol delivery device comprising: a region configured to be received by a holder; a controller configured to establish a data communication link with the holder; wherein the controller comprises a memory element configured to store user profile information for the aerosol delivery device; and wherein the controller is configured to selectively transmit user profile information from the memory element to the holder over the data communication link, and / or to receive user profile information from the holder over the data communication link and store the user profile information on the memory element.

### BRIEF DESCRIPTION OF THE DRAWINGS

Embodiments of the disclosure will now be described, by way of example only, with reference to the accompanying drawings, in which:

FIG. 1 is a schematic diagram of an aerosol delivery device in accordance with some embodiments of the disclosure.

FIG. 2 is a schematic diagram of an aerosol delivery system in accordance with some embodiments of the disclosure.

FIG. 3 is a schematic diagram of a holder for an aerosol delivery device in accordance with some embodiments of the disclosure.

FIG. 4 is a flowchart describing a method of operating a holder for an aerosol delivery device in accordance with some embodiments of the disclosure.

### DETAILED DESCRIPTION

Aspects and features of certain examples and embodiments are discussed / described herein. Some aspects and features of certain examples and embodiments may be implemented conventionally and these are not discussed / described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol delivery systems (which may also be referred to as vapour delivery systems) such as nebulisers or e-cigarettes. Throughout the following description the term “e-cigarette” or “electronic cigarette” may sometimes be used, but it will be appreciated this term may be used interchangeably with aerosol delivery system / device and electronic aerosol delivery system / device. Furthermore, and as is common in the technical field, the terms “aerosol” and “vapour”, and related terms such as “vaporise”, “volatilise” and “aerosolise”, may generally be used interchangeably.

Aerosol delivery devices (e-cigarettes) often, though not always, comprise a modular assembly including both a reusable part and a replaceable (disposable) cartridge part. Often the replaceable cartridge part will comprise the aerosol generating material and the vaporiser and the reusable part will comprise the power supply (e.g. rechargeable power source) and control circuitry. It will be appreciated these different parts may comprise further elements depending on functionality. For example, the reusable device part will often comprise a user interface for receiving user input and displaying operating status characteristics, and the replaceable cartridge part in some cases comprises a temperature sensor for helping to control temperature. Cartridges are electrically and mechanically coupled to a control unit for use, for example using a screw thread, bayonet, or magnetic coupling with appropriately arranged electrical contacts. When the aerosol generating material in a cartridge is exhausted, or the user wishes to switch to a different cartridge having a different aerosol generating material, a cartridge may be removed from the control unit and a replacement cartridge attached in its place. Devices conforming to this type of two-part modular configuration may generally be referred to as two-part devices.

It is common for electronic cigarettes to have a generally elongate shape. For the sake of providing a concrete example, certain embodiments of the disclosure described herein will be taken to comprise this kind of generally elongate two-part device employing disposable cartridges. However, it will be appreciated the underlying principles described herein may equally be adopted for different aerosol delivery device configurations, for example single-part devices or modular devices comprising more than two parts, refillable devices and single-use disposable devices, as well as devices conforming to other overall shapes, for example based on so-called box-mod high performance devices that typically have a more boxy shape. More generally, it will be appreciated certain embodiments of the disclosure are based on aerosol delivery devices which are operationally configured to provide functionality in accordance with the principles described herein and the constructional aspects of the aerosol delivery devices configured to provide the functionality in accordance with certain embodiments of the disclosure is not of primary significance.

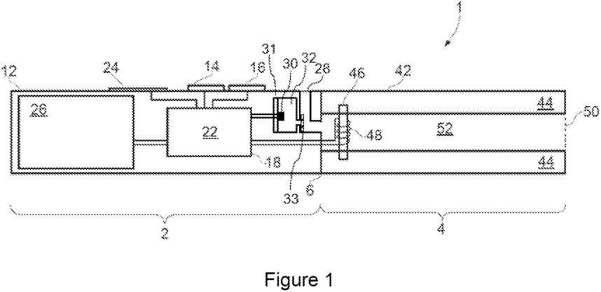

FIG. 1 is a schematic, cross-sectional view through an example aerosol delivery device 1 in accordance with certain embodiments of the disclosure. The aerosol delivery device 1 comprises two main components, namely a reusable part 2 and a replaceable / disposable cartridge part 4, which may also be referred to herein as a consumable part. In normal use the reusable part 2 and the cartridge part 4 are releasably coupled together at an interface 6. When the cartridge part is exhausted or the user simply wishes to switch to a different cartridge part, the cartridge part may be removed from the reusable part and a replacement cartridge part attached to the reusable part in its place. The interface 6 provides a structural, electrical and airflow path connection between the two parts and may be established in accordance with conventional techniques, for example based around a screw thread, magnetic or bayonet fixing with appropriately arranged electrical contacts and openings for establishing the electrical connection and airflow path between the two parts as appropriate. The specific manner by which the cartridge part 4 mechanically mounts to the reusable part 2 is not significant to the principles described herein, but for the sake of a concrete example is assumed here to comprise a magnetic coupling (not represented in FIG. 1). It will also be appreciated the interface 6 in some implementations may not support an electrical and / or airflow path connection between the respective parts. For example, in some implementations an aerosol generator may be provided in the reusable part 2 rather than in the cartridge part 4, or the transfer of electrical power from the reusable part 2 to the cartridge part 4 may be wireless (e.g. based on electromagnetic induction), so that an electrical connection between the reusable part and the cartridge part is not needed. Furthermore, in some implementations the airflow through the electronic cigarette might not go through the reusable part so that an airflow path connection between the reusable part and the cartridge part is not needed. In some instances, a portion of the airflow path may be defined at the interface between portions of reusable part 2 and cartridge part 4 when these are coupled together for use.

The cartridge part 4 may in accordance with certain embodiments of the disclosure be broadly conventional. In FIG. 1, the cartridge part 4 comprises a cartridge housing 42 formed of a plastics material. The cartridge housing 42 supports other components of the cartridge part and provides the mechanical interface 6 with the reusable part 2. The cartridge housing is generally circularly symmetric about a longitudinal axis along which the cartridge part couples to the reusable part 2. In this example the cartridge part has a length of around 4 cm and a diameter of around 1.5 cm. However, it will be appreciated the specific geometry, and more generally the overall shapes and materials used, may be different in different implementations.

Within the cartridge housing 42 is a reservoir 44 that contains aerosol generating material. Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise plant material such as tobacco. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt%, 60 wt% or 70 wt% of amorphous solid, to about 90 wt%, 95 wt% or 100 wt% of amorphous solid. The aerosol-generating material may comprise one or more active substances and/or flavours, one or more aerosol-former materials, and optionally one or more other functional material. The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The one or more other functional materials may comprise one or more of pH regulators, colouring agents, preservatives, binders, fillers, stabilizers, and/or antioxidants. The aerosol-generating material may be present on or in a support, to form a substrate. The support may, for example, be or comprise paper, card, paperboard, cardboard, reconstituted material, a plastics material, a ceramic material, a composite material, glass, a metal, or a metal alloy.

One or more active constituents / substances comprised in the consumable part may comprise one or more physiologically and/or olfactory active constituents which are included in the aerosolisable material in order to achieve a physiological and/or olfactory response in the user. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, cannabinoids, or mixtures thereof. Cannabinoids are a class of natural or synthetic chemical compounds which act on cannabinoid receptors (i.e., CB1 and CB2) in cells that repress neurotransmitter release in the brain. Two of the most important cannabinoids are tetrahydrocannabinol (THC) and cannabidiol (CBD). Cannabinoids may be naturally occurring (Phytocannabinoids) from plants such as cannabis, (endocannabinoids) from animals, and artificially manufactured (Synthetic cannabinoids). Cannabinoids are cyclic molecules exhibiting particular properties such as the ability to easily cross the blood-brain barrier, weak toxicity, and few side effects. Cannabis species express at least 85 different phytocannabinoids, and are divided into subclasses, including cannabigerols, cannabichromenes, cannabidiols, tetrahydrocannabinols, cannabinols and cannabinodiols, and other cannabinoids, such as cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabmolic acid (THCA), and tetrahydrocannabivarinic acid (THCV A).

In the example shown schematically in FIG. 1, a reservoir 44 is provided configured to store a supply of liquid aerosol generating material. In this example, the liquid reservoir 44 has an annular shape with an outer wall defined by the cartridge housing 42 and an inner wall that defines an airflow path 52 through the cartridge part 4. The reservoir 44 is closed at each end with end walls to contain the aerosol generating material. The reservoir 44 may be formed in accordance with conventional techniques, for example it may comprise a plastics material and be integrally moulded with the cartridge housing 42.

The cartridge part further comprises an aerosol generator 48 located towards an end of the reservoir 44 opposite to the mouthpiece outlet 50. An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

It will be appreciated that in a two-part device such as shown in FIG. 1, the aerosol generator may be in either of the reusable part 2 or the cartridge part 4. For example, in some embodiments, the aerosol generator 48 (e.g. a heater) may be comprised in the reusable part 2, and is brought into proximity with a portion of aerosol generating material in the cartridge 4 when the cartridge is engaged with the reusable part 2. In such embodiments, the cartridge may comprise a portion of aerosol generating material, and an aerosol generator 48 comprising a heater is at least partially inserted into or at least partially surrounds the portion of aerosol generating material as the cartridge 4 is engaged with the reusable part 2. An aerosol delivery device configured in this manner may be referred to as a tobacco heating device or a ‘heat not burn’ device (noting that other botanicals other than tobacco may be heated in such a device).

In the example of FIG. 1, a wick 46 in contact with a heater 48 extends transversely across the cartridge airflow path 52 with its ends extending into the reservoir 44 of a liquid aerosol generating material through openings in the inner wall of the reservoir 44. The openings in the inner wall of the reservoir are sized to broadly match the dimensions of the wick 46 to provide a reasonable seal against leakage from the liquid reservoir into the cartridge airflow path without unduly compressing the wick, which may be detrimental to its fluid transfer performance.

The wick 46 and heater 48 are arranged in the cartridge airflow path 52 such that a region of the cartridge airflow path 52 around the wick 46 and heater 48 in effect defines a vaporisation region for the cartridge part 4. Aerosol generating material in the reservoir 44 infiltrates the wick 46 through the ends of the wick extending into the reservoir 44 and is drawn along the wick by surface tension / capillary action (i.e. wicking). The heater 48 in this example comprises an electrically resistive wire coiled around the wick 46. In the example of FIG. 1, the heater 48 comprises a nickel chrome alloy (Cr20Ni80) wire and the wick 46 comprises a glass fibre bundle, but it will be appreciated the specific aerosol generator configuration is not significant to the principles described herein. In use electrical power may be supplied to the heater 48 to vaporise an amount of aerosol generating material (aerosol generating material) drawn to the vicinity of the heater 48 by the wick 46. Vaporised aerosol generating material may then become entrained in air drawn along the cartridge airflow path from the vaporisation region towards the mouthpiece outlet 50 for user inhalation.

As noted above, the rate at which aerosol generating material is vaporised by the vaporiser (heater) 48 will depend on the amount (level) of power supplied to the heater 48. Thus electrical power can be applied to the heater to selectively generate aerosol from the aerosol generating material in the cartridge part 4, and furthermore, the rate of aerosol generation can be changed by changing the amount of power supplied to the heater 48, for example through pulse width and/or frequency modulation techniques.

The reusable part 2 comprises an outer housing 12 having with an opening that defines an air inlet 28 for the e-cigarette, a power source 26 (for example a battery) for providing operating power for the electronic cigarette, control circuitry 18 for controlling and monitoring the operation of the electronic cigarette, a first user input button 14, a second user input button 16, and a visual display 24.

The outer housing 12 may be formed, for example, from a plastics or metallic material and in this example has a circular cross section generally conforming to the shape and size of the cartridge part 4 so as to provide a smooth transition between the two parts at the interface 6. In this example the reusable part has a length of around 8 cm so the overall length of the e-cigarette when the cartridge part and reusable part are coupled together is around 12 cm. However, and as already noted, it will be appreciated that the overall shape and scale of an electronic cigarette implementing an embodiment of the disclosure is not significant to the principles described herein.

The air inlet 28 connects to an airflow path 51 through the reusable part 2. The reusable part airflow path 51 in turn connects to the cartridge airflow path 52 across the interface 6 when the reusable part 2 and cartridge part 4 are connected together. Thus, when a user inhales on the mouthpiece opening 50, air is drawn in through the air inlet 28, along the reusable part airflow path 51, across the interface 6, through the aerosol generation region in the vicinity of the aerosol generator 48 (where vaporised aerosol generating material becomes entrained in the air flow), along the cartridge airflow path 52, and out through the mouthpiece opening 50 for user inhalation.

The power source 26 in this example is rechargeable and may be of a conventional type, for example of the kind normally used in electronic cigarettes and other applications requiring provision of relatively high currents over relatively short periods. The power source 26 may be recharged through a charging connector in the reusable part housing 12, for example a USB connector.

First and second user input buttons 14, 16 may be provided, which in this example are conventional mechanical buttons, for example comprising a spring mounted component which may be pressed by a user to establish an electrical contact. In this regard, the input buttons may be considered input devices for detecting user input and the specific manner in which the buttons are implemented is not significant. The buttons may be assigned to functions such as switching the aerosol delivery device 1 on and off, and adjusting user settings such as a power to be supplied from the power source 26 to an aerosol generator 48. However, the inclusion of user input buttons is optional, and in some embodiments buttons may not be included. In some embodiments, the display 24 is a touch-screen display (such as a touch-screen LCD display) which can allow a user to provide inputs to controller 22, and also display indications from a controller 22 to the user.

A display 24 may be provided to give a user with a visual indication of various characteristics associated with the aerosol delivery device, for example current power setting information, remaining power source power, and so forth. The display may be implemented in various ways. In this example the display 24 comprises a conventional pixilated LCD screen that may be driven to display the desired information in accordance with conventional techniques. In other implementations the display may comprise one or more discrete indicators, for example LEDs, that are arranged to display the desired information, for example through particular colours and / or flash sequences. More generally, the manner in which the display is provided and information is displayed to a user using the display is not significant to the principles described herein. For example some embodiments may not include a visual display and may include other means for providing a user with information relating to operating characteristics of the aerosol delivery device, for example using audio or haptic signalling, or may not include any means for providing a user with information relating to operating characteristics of the aerosol delivery device.

In embodiments of the present disclosure, a controller 22 is suitably configured / programmed to control the operation of the aerosol delivery device to provide functionality in accordance with embodiments of the disclosure as described further herein, as well as for providing conventional operating functions of the aerosol delivery device in line with the established techniques for controlling such devices. The controller (processor circuitry) 22 may be considered to logically comprise various sub-units / circuitry elements associated with different aspects of the operation of the aerosol delivery device 1. In this example the controller 22 comprises power supply control circuitry for controlling the supply of power from the power source 26 to the aerosol generator 48 in response to user input, user programming circuitry 20 for establishing configuration settings (e.g. user-defined power settings) in response to user input, as well as other functional units / circuitry associated functionality in accordance with the principles described herein and conventional operating aspects of electronic cigarettes, such as display driving circuitry and user input detection circuitry. It will be appreciated the functionality of the controller 22 can be provided in various different ways, for example using one or more suitably programmed programmable computer(s) and / or one or more suitably configured application-specific integrated circuit(s) / circuitry / chip(s) / chipset(s) configured to provide the desired functionality. For example, the controller 22 may comprise a chip such as an application specific integrated circuit (ASIC) or microcontroller, for controlling the aerosol delivery device 1. The microcontroller or ASIC may include a CPU or micro-processor. The operations of the CPU and other electronic components are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required. As described further herein, the microcontroller also contains appropriate communications interfaces (and control software) for communicating as appropriate with other components of the aerosol delivery device 1, and one or more other electronic devices of a wider aerosol delivery system / ecosystem.

Reusable part 2 may comprise an airflow sensor 30 which is electrically connected to the controller 22. In most embodiments, the airflow sensor 30 comprises a so-called “puff sensor”, in that the airflow sensor 30 is used to detect when a user is puffing on the device. In some embodiments, the airflow sensor comprises a switch in an electrical path providing electrical power from the power source 26 to the aerosol generator 48. In such embodiments, the airflow sensor 30 generally comprises a pressure sensor configured to close the switch when subjected to an particular range of pressures, enabling current to flow from the power source 26 to the aerosol generator 48 once the pressure in the vicinity of the airflow sensor 30 drops below a threshold value. The threshold value can be set to a value determined by experimentation to correspond to a characteristic value associated with the initiation of a user puff. In other embodiments, the airflow sensor 30 is connected to the controller 22, and the controller distributes electrical power from the power source 26 to the aerosol generator 48 in dependence of a signal received from the airflow sensor 30 by the controller 22. The specific manner in which the signal output from the airflow sensor 30 (which may comprise a measure of capacitance, resistance or other characteristic of the airflow sensor, made by the controller 22) is used by the controller 22 to control the supply of power from the power source 26 to the aerosol generator 48 can be carried out in accordance with any approach known to the skilled person. In other embodiments, a different user input scheme (e.g. using one of optional buttons 14 and 16, or a touchscreen display 24) may be used to activate the heater 48 and initiate a supply of aerosol to a user (for example during the duration of a button press by the user).

In the example shown in FIG. 1, the airflow sensor 30 is mounted to a printed circuit board 31 as described further herein, but this is not essential. The airflow sensor 30 may comprise any sensor which is configured to determine a characteristic of airflow in an airflow path 51 disposed between air inlet 28 and mouthpiece opening 50, for example a pressure sensor or transducer (for example a membrane or solid-state pressure sensor), a combined temperature and pressure sensor, or a microphone (for example an electret-type microphone), which is sensitive to changes in air pressure, including acoustical signals. The airflow sensor is situated within a sensor cavity 32, which comprises the interior space defined by one or more chamber walls 34. The sensor cavity 32 may also be referred to herein as a sensor chamber 32 (these terms may be used interchangeably), and comprises a region internal to one or more chamber walls 34 in which an airflow sensor 30 can be fully or partially situated. In some embodiments, the airflow sensor 30 is mounted to a printed circuit board (PCB) 31, which comprises one of the chamber walls of a sensor housing comprising the sensor chamber / cavity 32. A deformable membrane 33 is disposed across an opening communicating between the sensor cavity 32 containing the sensor 30, and a portion of the airflow path disposed between air inlet 28 and mouthpiece opening 50. The deformable membrane 33 covers the opening, and is attached to one or more of the chamber walls according to approaches described further herein.

In embodiments of the disclosure, the controller 22 of the aerosol delivery device 1 is configured to provide control functions to the aerosol delivery device, which may include, for example, logging data relating to the usage of the aerosol delivery device by a user, and establishing values for control parameters which define aspects of functionality of the aerosol delivery device 1 and its constituent components. Such data may generally herein be termed ‘user profile information’. User profile information may be stored on a memory element (such as a RAM module or other digital memory element known to the skilled person) integrated into controller 22, or may be stored on a separate standalone memory element comprised in aerosol delivery device 1 (not shown) and configured with a data communication link to controller 22. Broadly, user profile information may be classified into two classes of information / data: (i) data relating to behaviour and / or identity of the user (comprising, for example, information about interaction of the user with the aerosol delivery device, the location of the user and / or aerosol delivery device, and / or identifying information about the user, such as for example biometric data and / or user preferences), and (ii) data relating to control of the device (comprising, for example, control parameters, usage modes, software, and firmware).

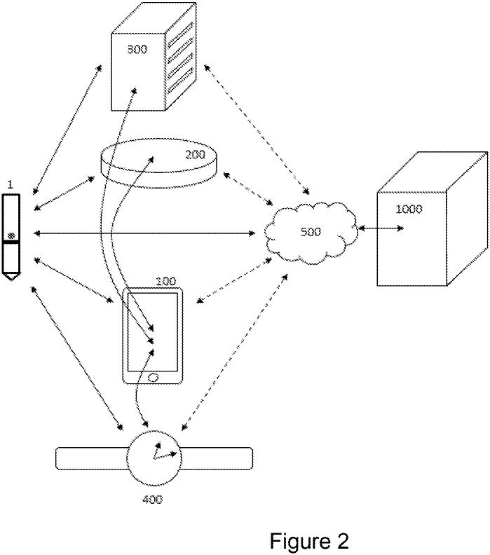

Thus, in some embodiments user profile information may comprise usage data relating to the interaction of a user with the aerosol delivery device and / or the identity of the user, such as, for example:
Usage data relating to the manner in which a user interacts with the aerosol delivery device. This may comprise any of, for example, an average number of puffs per unit time (e.g. per hour, day, or week), or a total or average puff duration in seconds with respect to an interval of time (e.g. an hour, day, or week), as determined by the controller 22 on the basis of monitoring signals received from airflow sensor 30. Usage data may also comprise a record of different consumables used with the aerosol delivery device (e.g. what aerosol generating materials have been used over a predetermined period, and optionally in what respective quantities, in terms of, for example, number of cartridges or articles consumed over a period of time). This may be determined by sensing via a sensor connected to controller 22 an identifier (e.g. RFID tag or QR code) comprised in or on a cartridge or article 4 when the cartridge 4 is coupled to the reusable device part 2. The controller 22 may retrieve data from the identifier indicating, for example, an amount and / or type of aerosol generating material in the cartridge 4, and / or information about a heater 48 in the cartridge 4, and / or instructions for the controller 22 setting out how to supply energy to the cartridge 4 to aerosolise aerosol generating material comprised in the cartridge 4.
Usage data comprising user context data, which may be determined by controller 22, or by controller circuitry associated with an electronic device external to the aerosol delivery device 1. Such data may comprise, for example, location data such as GPS data collected by the controller 22, or by an external electronic device, for example, a smartphone 100 or wearable device 400 associated with a user of the aerosol delivery device. Location data may comprise a record of how the location of the aerosol delivery device and / or user has changed over time. This may be based on the assumption that for a portable electronic device carried by a user (e.g. a smartphone), the location of the electronic device will generally correspond to the location of the user. Location data collected by an external device may be transmitted to the aerosol delivery device 1 via a wired or wireless data interface as described further herein.
Usage data comprising processed data generated by analysis of raw usage data collected by the aerosol delivery device 1, or by one or more other electronic devices in the aerosol delivery device shown schematically in FIG. 2. Usage data comprising processed data may be derived using any data processing approach known to the skilled person. For example, in one example processed data is derived from raw puff data, where the raw puff data comprises information about the start and end times of a plurality of puffs taken by the user, as determined by controller 22 on the basis of signals from an airflow sensor 30. Analysis of this raw data to derive processed data may comprise averaging the raw puff data to determine an average number of puffs per unit time (e.g. per hour, day, or week), or may comprise determining an average puff duration (e.g. in seconds). More generally, usage data comprising processed data may comprise data resulting from analysis / processing of data relating to parameters monitored by the controller of aerosol delivery device 1 (which may include, for example, location, heating temperature, ambient temperature, battery voltage, etc).

Another class of user profile information comprises control data (e.g. comprising control parameter) which may be used by controller 22 to modify operation of the aerosol delivery device 1 and its constituent components, such as, for example,
Control data comprising values or ranges for one or more control parameters, such as an amount of power to supply to a heater 48 of the aerosol delivery device 1 during a puff. For example, the user data may comprise a single value for power (e.g. expressed in Watts) to be delivered from battery 26 to heater 48 by controller 22, or a range of values defined by an upper and lower bound (e.g. expressed in Watts), between which power delivery from battery 26 to the heater 48 may be dynamically varied by controller 22 on the basis of, for example, the rate of airflow through the device as determined based on signals received by controller 22 from airflow sensor 30.
Control data comprising a heating profile, defining variation over time of power to be delivered from battery 26 to a heater 48 by controller 22. For example, the heating profile may define a rate of power increase over a first time interval to be supplied to heater 48 following detection of a user puff (as determined by controller 22 based on a signal from airflow sensor 30), and a subsequent power level to maintain during a second time interval extending from the end of the first time interval until the point at which the controller 22 detects via signals from the airflow sensor 30 that the user has ceased to puff on the aerosol delivery device 1.
Control data comprising preferences relating to customisation of non-heating aspects of device operation by a user, such as, for example, a colour scheme to be used when displaying information on a display 24, and / or a brightness or contrast level for display 24.
Control data comprising cessation control information, specifying for example how much aerosol a user is allowed to generate using the device in a predefined period of time, and optionally preventing aerosol generation if the allowed amount of aerosol is reached within the predefined period of time.
More generally, it will be appreciated control data may comprise any parameter which may be used by controller 22 to determine one or more aspects of control of an aerosol delivery device 1 or an external electronic device connectable to the aerosol delivery device via a data communication link.

Where the user profile information relates to control parameters for an aerosol delivery device, these may be set in manufacture of the device, input via a user input interface on the device (for example one or more buttons on the housing of the aerosol delivery device 1, a touchscreen display on the aerosol delivery device), or input via an external electronic device (e.g. via an APP running on smartphone 100) which transmits the control parameters to the aerosol delivery device 1 via a wired or wireless interface as described further herein.

In some examples, user profile information comprising control parameters are determined on the basis of analysing raw user profile information representing interaction with the device by a user over time. For example, raw usage data (e.g. one or more parameters monitored by one or more sensors or input devices) describing a distribution of user puffs over the course of one or more days may be analysed to identify time periods where use of the device is particularly frequent. These periods may be considered to be high-demand periods where it is desirable to provide a greater quantity of aerosol to the user per puff. Thus user profile information may be established comprising control data in which the power supplied to the heater per puff is varied over time throughout each day, with a higher power level being supplied in periods determined to be high usage periods on the basis of the puff distribution data. It will be appreciated that control data may be established on the basis of usage data in this way for other instances of control data and usage data as described further herein.

In some embodiments, user context information is used to establish a user profile. For example, the user may indicate (for example via an APP running on smartphone 100) that certain geographical locations should be associated with different operation of the aerosol delivery device. For example, GPS region corresponding to the user’s home may be associated with a first power level (for example to target a certain aerosol visibility), and a GPS region corresponding to the user’s work may be associated with a second, different power level (for example to target a different aerosol visibility).

The controller 22 of the aerosol delivery device 1 may be configured to store user information comprising a plurality of user profiles which may be selectable by the user (for example using an input interface as described further herein), or the controller 22 may be configured to store a single user profile which can be superseded by loading a new user profile onto the controller via a wired or wireless data transfer connection with an external electronic device, as described further herein. In some embodiments, user profile information comprises a plurality of control profiles, where each user profile comprises a selectable set of user profile information. For example, a first user profile may comprise control data specifying a certain power to be delivered to a heater, and / or a colour scheme to be used when displaying indications on a display, and / or cessation control information, and / or any other control data / parameter described herein. In addition, or instead of control data, the first user profile may comprise usage data collected by the controller, which may comprise usage data obtained while the aerosol delivery device is being operated according to control data comprised in the first profile, and may comprise any usage data described herein. A second user profile may also comprise control data specifying a certain power to be delivered to a heater, and / or a colour scheme to be used when displaying indications on a display, and / or cessation control information, and / or any other control data / parameter described herein, where this data differs from the control data in the first user profile. In addition, or instead of control data, the second user profile may comprise usage data collected by the controller, which may comprise usage data obtained while the aerosol delivery device is being operated according to control data comprised in the second profile, and may comprise any usage data described herein. One or more additional such user profiles may be comprised in the user profile information. Establishing user profiles may be considered advantageous in allowing control data comprising one or more control parameters, and / or usage data, to be stored in a controller 22 in an identifiable and sharable form. Where a plurality of usage profiles are stored on a memory element of the aerosol delivery device 1, these may be

A user profile may be established by inputting values for one or more control parameters as described further herein. For example, using a user input interface on the aerosol delivery device, or an APP running on a separate electronic device, a user may set up one or more profiles by inputting values for each of a plurality of control parameters as described further herein. A plurality of user profiles may be established in this way, which may be separately identifiable and selectable, for example having different names. For example, a user may have a ‘morning’ profile and an ‘evening’ profile, with different control data set up for each profile in order to target the user’s preferences during use of the aerosol delivery device during morning and evening respectively (for example in terms of preferred power delivered to the heater). Or an aerosol delivery device may be usable by a plurality of users, who may each have a user profile, where each user profile comprises control data targeting that specific user’s preferences, and / or comprises usage data collected / generated by the device when said user is using the aerosol delivery device. Where a plurality of user profiles are stored on the aerosol delivery device, the currently active profile may be changed using a user input interface on the aerosol delivery device, or an APP running on an external electronic device. Where the currently active user profile comprises control data, these may be used to control the operation of the aerosol delivery device whilst the user profile is active. Where he currently active user profile comprises usage data, usage data collected whilst the user profile is active may be assigned to the user profile.

As described further herein, the aerosol delivery device 1 comprises communication circuitry configured to enable a connection to be established with one or more external electronic devices in a wider aerosol delivery system / ecosystem (comprising for example, a storage / charging case / holder, and / or a refill / charging dock) to enable data transfer between the aerosol delivery device 1 and further electronic device(s). In some embodiments, the communication circuitry is integrated into controller 22, and in other embodiments it is implemented separately (comprising, for example, separate application-specific integrated circuit(s) / circuitry / chip(s) / chipset(s)). For example, the communication circuitry may comprise a separate module to the controller 22 which, while connected to controller 22, provides dedicated data transfer functionality for the aerosol delivery device. In some embodiments, the communication circuitry is configured to support communication between the aerosol delivery device 1 and one or more further electronic devices over a wireless interface. The communication circuitry may be configured to support wireless communications between the aerosol delivery device 1 and other electronic devices such as a case, a dock, a computing device such as a smartphone or PC, a base station supporting cellular communications, a relay node providing an onward connection to a base station, a wearable device, or any other portable or fixed device which supports wireless communications. Wireless communications between the aerosol delivery device 1 and a further electronic device may be configured according to known data transfer protocols such as Bluetooth, ZigBee, WiFi, Wifi Direct, GSM, 2G, 3G, 4G, 5G, LTE, NFC, RFID. More generally, it will be appreciated that any wireless network protocol can in principle be used to support wireless communication between the aerosol delivery device 1 and further electronic devices. In some embodiments, the communication circuitry is configured to support communication between the aerosol delivery device 1 and one or more further electronic devices over a wired interface. This may be instead of or in addition to the configuration for wireless communications set out above. The communication circuitry may comprise any suitable interface for wired data connection, such as USB-C, micro-USB or Thunderbolt interfaces. More generally, it will be appreciated the communication circuitry may comprise any wired communication interface which enables the transfer of data, according to, for example, a packet data transfer protocol, and may comprise pin or contact pad arrangements configured to engage cooperating pins or contact pads on a dock, case, cable, or other external device which can be connected to the aerosol delivery device 1.

Referring now to FIG. 2, the aerosol delivery device 1 (or more generally any delivery device as described elsewhere herein) may operate within a wider delivery system / aerosol delivery device comprising one or more of a smartphone 100, a dock 200 (e.g. a storage / charging case or home refill and/or charging station), a personal computer (PC) 300, or a wearable device 400 (e.g. a smart watch), and a server 1000 (where communications with the server may be supported over an internet or other packet data connection 500). The electronic devices comprised in the system may communicate with the aerosol delivery device 1, either directly (as shown with solid arrows) or indirectly (shown with dashed arrows). This delivery system may be referred to as a delivery ecosystem / aerosol delivery ecosystem.

An example aerosol delivery device 1 such as an e-cigarette may communicate directly with one or more other classes of device in a wider aerosol delivery ecosystem, including but not limited to a smartphone 100, a dock 200 (e.g. a recharging case or home refill and/or charging station), a personal computer (PC) 300, or a wearable device 400 (e.g. a smart watch). In a similar manner, the aerosol delivery device 1 such as an e-cigarette may communicate directly with another device of the same class, i.e. another aerosol delivery device. As noted above, these devices may cooperate in any suitable configuration to form a delivery system 1. This communication may be supported by wired communication circuitry of the aerosol delivery device 1 (for example, using an interface such as USB-C, micro-USB, Thunderbolt, or another wired communication interface as described further herein), or by wireless communication circuitry of the aerosol delivery device 1 (for example, a Bluetooth, ZigBee, WiFi, Wifi Direct, GSM, 2G, 3G, 4G, 5G, LTE, NFC or RFID module, or another wireless communication interface as described further herein). The aerosol delivery device 1 may be configured to connect to different ones of other classes of device using different wired or wireless communication protocols, and a data connection between the aerosol delivery device 1 and any given second device may be established using wired and / or wireless communication. It will be appreciated that other classes of device comprised in the wider delivery system may comprise communication circuitry for wired or wireless data transmission similar to that set out further herein in relation to the aerosol delivery device 1. Accordingly, a smartphone 100, a dock 200 (e.g. a home refill and/or charging station), a personal computer (PC) 300, a wearable device 400 (e.g. a smart watch) or a server 1000 may be equipped with communication circuitry comprising a Bluetooth, ZigBee, WiFi, Wifi Direct, GSM, 2G, 3G, 4G, 5G, LTE, NFC, RFID or other wireless transmission module, and / or a wired interface such as USB-C, micro-USB, Thunderbolt or other wired interface. Communication circuitry of the aerosol delivery device 1 (implemented as a single module or separate modules) may enable it to communicate with different ones of the further classes of device using different wired and / or wireless data transmission protocols.

The aerosol delivery device 1 and other classes of device in the delivery system may communicate directly or indirectly with a server 1000 via a network such as the internet 500 or other suitable packet data protocol known to the skilled person (such as those set out in the 3GPP standards for cellular wireless communications). The aerosol delivery device 1 may establish such communication directly, using one of the wireless communication protocols described further herein to communicate with communication node /transceiver infrastructure (such as a ‘base station’ or ‘evolved node-B’ in LTE terminology) which provides connectivity with the server 1000 (e.g. over a backhaul communication link). Alternatively or in addition, the aerosol delivery device 1 may establish communication with the server 1000 via another device in the delivery system 1, for example using a wired or wireless communication protocol to communicate with a smartphone 100, a dock / case 200, a personal computer (PC) 300, or a wearable device 400 which then communicates with the server 1000 (for example, via the internet 500) to either relay data to or from the aerosol delivery device 1, report upon its communications with the aerosol delivery device 1, or exchange information inferred about the aerosol delivery device 1 without a connection to the aerosol delivery device 1 being established. The smartphone 100, dock 200, or other device within the delivery ecosystem, such as a point of sale system / personal computer (PC) 300, may optionally act as a hub for one or more aerosol delivery devices 1 that only have short range transmission capabilities (provided, for example, by communication circuitry comprising a Bluetooth or RFID module). Such a hub may thus extend the battery life of an aerosol delivery device 1 whilst enabling data to be exchanged between the aerosol delivery device 1 and further devices of the aerosol delivery device 1 (for example, server 1000).

The other classes of device in the aerosol delivery device 1, such as the smartphone 100, dock 200, personal computer (or, for example, a point of sale system) 300 and/or wearable 400 may also communicate indirectly with the server 1000 via a relay device, either to fulfil an aspect of their own functionality, or on behalf of the aerosol delivery device 1 (for example as a relay or co-processing unit). These devices may also transfer data with each other, either directly or indirectly via any of the wired or wireless communication protocols set out further herein.

A given first and second electronic device of the delivery system (e.g. an aerosol delivery device 1 and a smartphone 100) may generally be in either a connected or unconnected state. The unconnected state may also be referred to as an idle state, and in such a state a given first device may not be detectable by other second devices (i.e. the first device is not transmitting any signalling enabling its existence and / or identity to be determined), or it may be available for establishing a connection with a second device (i.e. it may be advertising its existence / identity using beacon / advertisement signalling). In a connected state, the first and second devices are configured such that data may be transferred from the first to the second device (e.g. ‘uplink’ transmission) and / or transferred from the second to the first device (e.g. ‘downlink’ transmission). Accordingly, establishment of a connection between a first and second device may be considered to comprise the establishment of any state wherein the two devices can exchange data, regardless of the direction of data transfer. Non-limiting examples of connected states are the establishment of an RRC connected state according to the Long Term Evolution (LTE) standard, or a bonded / paired state according to the Bluetooth standard.

When a first and second device of the delivery system are configured to communicate wirelessly, a transition from an unconnected to a connected state will generally follow a procedure such as the following. In an initial enquiry step, a first device (for example, an aerosol delivery device 1) establishes the existence of a second device (for example, a smartphone 100 or case 200) by receiving a beacon signal or other identifying signal / message from the second device. In an authentication step, the first and second devices exchange messaging to establish information relating to the data transfer protocol to be used for exchanging data (for example comprising coding and encryption parameters to be used when exchanging data packets). In a data transfer step, the first and second devices transfer data over an air interface established in accordance with an agreed data transfer protocol (for example, Bluetooth, ZigBee, RFID, or other protocols described further herein). This data transmission may be bi- or uni-directional. The data communication process for wired communications may be broadly similar with the difference that data is transmitted over a wired interface as opposed to a wireless interface. Further aspects of implementation for establishment of wireless and wired communications may be found in the standard documents for communication protocols such as those listed further herein.

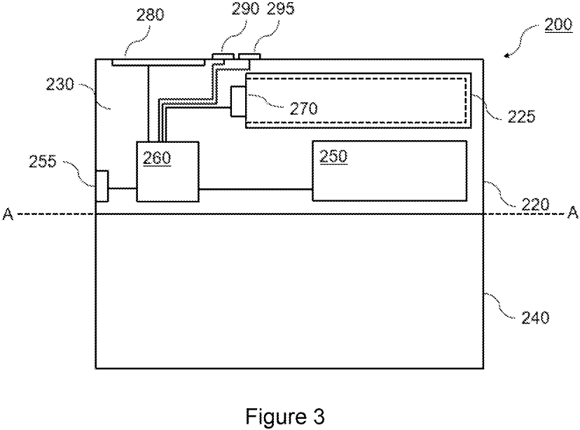

FIG. 3 shows schematically a charging / storage holder 200 for receiving and accommodating an aerosol delivery device 1 in accordance with some embodiments of the present disclosure. The holder may be referred to herein as a case. The case 200 comprises a body 220 which is provided with a hinged lid 240 that can open and close. The body 220 comprises an outer case or housing which is configured with an internal space into which an aerosol delivery device 1 can be placed. For example, the case 200 may be fitted with an insert 230 which comprises features configured to retain an aerosol delivery device 1. For example, the insert may be provided with a recess 225 into which aerosol delivery device 1 may be received (a dotted line indicates an approximate position of an aerosol delivery device 1 when received in the recess 225). The shape of the recess may generally conform to the outer shape of the aerosol delivery device 1, and though in the highly schematic example shown in FIG. 3, the aerosol delivery device 1 and recess 225 have a rectangular outer profile, the shape of aerosol delivery device 1 (and correspondingly of recess 225) are not of particular significance to the present disclosure, and can take any form known to the skilled person.

FIG. 3 illustrates schematically the main components that are housed within the body 220 of the case 200, in accordance with some embodiments of the invention (some minor components, such as internal wiring, are omitted for reasons of clarity). The body includes a battery 250 and a controller 260. The body 220 may include a hinge or axle which couples the lid 240 to the body 220, provides a rotational degree of freedom around axis A-A, providing a pivot about which the lid 240 is able to open and shut to close the case 200.

Though the case shown in FIG. 3 has a configuration wherein a hinged lid 240 is opened to reveal an insert 230 with a recess 225 in which an aerosol delivery device 1 is housed, it will be appreciated that the particular manner in which the aerosol delivery device 1 is coupled to the case 200 is not of particular significance, and in other embodiments the case 200 may be configured such that, for example, an aerosol delivery device 1 may be slid into an elongate recess in the case via an aperture whose cross section may broadly correspond to a cross-section transverse to the long axis of the aerosol delivery device 1, and whose depth equates to at least the length of the aerosol delivery device 1. In this latter embodiment, a hinged or sliding lid may be configured to be moved between a covered and open position, in which the aperture is respectively covered or revealed. Where a lid is provided on a case, this may be configured in any suitable manner known to the skilled person, such as, for example, a hinging or sliding lid, or a lid which can be entirely removed and replaced. The lid 240 may be held in the closed position by a sliding catch which can be actuated by a user, or by cooperative magnets in the lid and the body 220 of the case 200, which retain the lid in the closed position by magnetic attraction when the lid is moved into the closed position by the user. In other embodiments, the case 200 only partially encloses the aerosol delivery device 1 when the aerosol delivery device 1 is coupled to the case 200.

An aerosol delivery device 1 placed in the recess 225 within the case 200 may be retained by, for example, one or more magnets associated with the recess, which are configured to attract one or more magnets or ferrous material portions (e.g. comprising or disposed within an outer housing) of an aerosol delivery device 1 when the aerosol delivery device 1 is placed in the recess 225. In other examples, the aerosol delivery device 1 may be sized relative to recess 225 such that there is an interference fit when the aerosol delivery device 1 is introduced between at least two opposing wall portions of recess 225 (e.g. where the recess 225 is rectangular, the long opposing walls may be spaced slightly closer together than the diameter of the aerosol delivery device, and the recess walls may comprise a resilient plastics material, such that the recess walls exert a slight compressive force against the aerosol delivery device 1 when it is disposed in the recess, causing the aerosol delivery device 1 to be retained in the recess 225). It will be appreciated the means used to retain the aerosol delivery device 225 in the case is not of particular significance, and any other means of retaining the aerosol delivery device 1 in the recess 225 of the case may be used by the skilled person.

The battery 250 of the case 200, which may be of a lithium ion type, will usually have significantly greater electrical storage capacity than a battery provided in an aerosol delivery device 1 which is to be accommodated within the case. This allows the battery in the aerosol delivery device 1 to be re-charged, typically several times, using the battery unit 250 of case 200, without the need for any additional, external power supply (such as a mains connection).

In order to support this re-charging of an aerosol delivery device 1 stored within the case 200, a charging interface 270 is provided to enable transfer of electrical power between the battery 250 of the case, and the battery of the aerosol delivery device 1. This may be provided in a number of different ways. For example, charging interface 270 may comprise an induction charging coil proximate to the recess 225 of the case 200, configured to transfer energy inductively to a corresponding induction charging coil in the aerosol delivery device 1, such that electrical energy from battery 250 is converted to electromagnetic energy, transferred wirelessly to aerosol delivery device 1, and converted back to electrical energy to charge battery of the aerosol delivery device 1. The recess 225 of the case 200 may be provided with a charging interface 270 comprising suitable electrical contacts at an end (or elsewhere) to provide a wired power supply for an aerosol delivery device 1 inserted into the recess, via contact with cooperative electrical contacts on the outer housing of the aerosol delivery device. The charging interface 270 may comprise a co-axial, micro-USB, USB-C, Thunderbolt, or other electrical connector, which is configured to mate with a corresponding connector on the housing of the aerosol delivery device 1 when the aerosol delivery device 1 is received in the recess 225 of the case 200. Any of the aforementioned charging interfaces 270 for the delivery of electrical energy from a case 200 to an aerosol delivery device 1 may also provide a data connection enabling one- or two-way data connectivity between the controller 22 of the aerosol delivery device 1 and a controller 260 of the case. The controller 260 of the case controls the charging interface 270 to supply electrical energy from battery 250 to an aerosol delivery device 1 received in recess 225.

The controller 260 of the case 200 may be implemented in the same or a similar manner as described herein for the controller 22 of the aerosol delivery device 1, and may thus be implemented using one or more suitably programmed programmable computer(s) and / or one or more suitably configured application-specific integrated circuit(s) / circuitry / chip(s) / chipset(s) configured to provide the desired functionality. The controller 260 may control all the functionality described herein for case 200, via suitable software or firmware running on the controller 260. As described further herein, the controller 260 may comprise wired or wireless communication circuitry configured for support wired and / or wireless data communications with one or more of a plurality of electronic devices such as a smartphone 100, a dock 200 (e.g. a recharging case or home refill and/or charging station), a personal computer (PC) 300, a wearable device 400, or a server 1000. Wireless communications between the controller 260 and external electronic devices (and / or aerosol delivery device 1) may be configured according to known data transfer protocols such as Bluetooth, ZigBee, WiFi, Wifi Direct, GSM, 2G, 3G, 4G, 5G, LTE, NFC, RFID. In addition to or in place of a wired data transfer interface 270, a wireless communication interface may also be provided between the controller 260 of the case and the controller of the aerosol delivery device 1, using wireless communication approaches set out further herein (e.g. as described in relation to FIG. 2). Wired connections between the controller 260 and one or more external electronic devices may be supported by a wired data interface such as USB-C, micro-USB, Thunderbolt or other wired interface (for example via a combined charging and data transfer interface 255). Communication circuitry of the case 200 (implemented as a single module or separate modules, which may be separate to or integrated within controller 260) may enable it to communicate with different ones of the further classes of device using different wired and / or wireless data transmission protocols, which may comprise for example any packet data protocol known to the skilled person. The battery 250 may be charged via a wired interface 255, or may be configured to be inductively charged via an inductive charging interface 255, using an inductive charging pad, tray or dock (not shown) which comprises a charging coil configured to transfer electrical energy wirelessly to the case via the inductive charging interface 255.

It will be appreciated that the configuration and arrangement of the case body / housing 220 and insert 230 shown in FIG. 3 are provided by way of example, and the skilled person will be aware of many potential variations - e.g. the shape of the recess 225, the external dimensions and shape of the case housing 220, the manner in which the lid 240 couples to the case (or whether a lid exists at all), and the configuration of charging interfaces (255, 270) and wireless data communication interfaces. Similarly, the details of the positioning, shape and size of the battery unit 250, controller 260, and other components will generally vary from one embodiment to another, depending upon the particular circumstances and requirements of any given implementation.

The controller 260 is configured to receive a plurality of inputs, on the basis of which a control process running on the controller 260 (e.g. suitable software) can control the functionality of the case 200. Such inputs may include, for example:
an indication of whether an external power supply available through a charging interface 255.
a level of charge in case battery 250. On the basis of this input, the case controller 260 may provide the user with an indication of this charge level via a display 280 on the housing 220, insert 230, or lid 240.
an indication of whether case lid 240 is open or shut according to input received from a suitable switch (e.g. microswitch) or sensor (e.g. a Hall effect sensor) configured to provide output indicative of the positional state of the lid.
an indication of the presence of an aerosol delivery device 1 in the recess 225.
user inputs provided by using a user input interface (290, 295) as described further herein.
whether the controller 260 has a paired wireless data connection with an external electronic device, or whether an external electronic device is available (e.g. within range) for forming a paired wireless data connection (as determined, for example, on the basis of beacon signalling received from an external device).

It will be appreciated that this set of control inputs is provided by way of example only, and other embodiments may not have all the above control inputs and/or may have additional control inputs known to the skilled person.

Where the charging interface 270 between case 200 and aerosol delivery device 1 is an induction charging interface, the presence of an aerosol delivery device 1 in the case 200 may be determined by the controller 260 on the basis of detecting a change in the effective inductance of a charging coil comprised in the charging interface, by virtue of the mutual inductance arising from a corresponding induction charging coil in the aerosol delivery device 1, and this change in effective inductance can be detected by controller 260. Alternatively, if the case uses a wired charging interface 270, the resistance across and/or current through the wired connection will change upon contact with a corresponding interface comprised in an aerosol delivery device 1, allowing the presence of the aerosol delivery device 1 to be detected by the controller 260. A further possibility is to use some other sensing or communication mechanism, e.g. mechanical, electrical, or optical, to determine the presence or absence of an aerosol delivery device 1 in the recess 225. For example, the base of the recess 225 may include a mechanical switch, which is activated when an aerosol delivery device 1 is seated in the recess. The skilled person will be aware of further possible mechanisms for detecting the presence of an aerosol delivery device 1 in the recess.

The outer housing 220 of the case 200 may be provided with a user input interface, 290 / 295, via which a user can provide inputs to the controller 260, as described further herein. Such inputs may relate to selection of user profiles, modes, or operating parameters for the case 200 and / or aerosol delivery device 1 as described further herein. The user input interface may optionally comprise, for example, one or more mechanical buttons (such as two buttons, 290 and 295) on an external housing 220 of the case 200, or a touch-screen LCD display 280 which provides combined functionality of displaying information to a user and allowing a user to provide user input. Alternatively or in addition, user inputs to the case controller 260 may be provided wirelessly via a wireless data connection with an external electronic device, configured as described further herein. For example, a data connection may be established between controller 260 and a smartphone 100 using a Bluetooth pairing procedure as described herein. An application (APP) running on the smartphone 100 may be used to display information relating to the operation of the case, via communication of control data (e.g. user data) between the controller 260 and control circuitry of the smartphone 100. User inputs to the smartphone APP (e.g. selection of menu options or control parameters) may be transmitted over the data connection to the case controller 260, and on the basis of these inputs, the controller 260 may control functions of the case 200, as described further herein. In this manner, an APP running on a smartphone 100 may be used to provide an external display and user input functionality for the controller 260, and the case 200 may not comprise any local user input interface (e.g. buttons) or display elements (e.g. LCD display or LEDs). The same principle of using an external electronic device to provide remote display and user input functionality for the case 200 may be applied in respect of other electronic devices as shown, for example in FIG. 2, such as a smartwatch, PC, or refill dock.

The inventors have recognised that an electronic device such as a storage or charging case configured for regular coupling with an aerosol delivery device (e.g. via a wired or wireless data connection as described further herein) may be used to support what may be broadly described as user profile / user data transmission between the aerosol delivery device and the electronic device. This may be considered advantageous, since an external electronic device (e.g. a charging / storage case, smartphone, wearable device, refill dock, or server), may comprise more extensive data storage and data processing capabilities than are available on the controller of the aerosol delivery device. An external electronic device may also be designed to have a longer operational life than an aerosol delivery device, and / or may be less prone to loss or damage, such an external electronic device may therefore provide what may be considered a ‘backup’ functionality, by storing user profiles / user data relating to functionality / operation of a first aerosol delivery device so these can be retrieved and uploaded to a second aerosol delivery device, for example if the first aerosol delivery device is broken, lost, or stolen.

Thus in some embodiments, a case 200 is configured to establish a data communication link between a controller 260 of the case 200 and a controller 22 of an aerosol delivery device 1 when the aerosol delivery device is received in a recess 225 of the case 200. The data communication link may be established using any wired or wireless communication interface and protocol as described further herein. In one example, the data communication link is formed by a case interface 270 comprising a male USB-C connector, which is received in a female USB-C connector located on the aerosol delivery device 1.

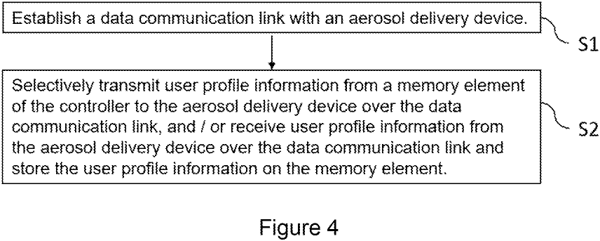

FIG. 4 shows a flowchart detailing aspects of operation of a holder / case according to the present disclosure. In a first step, S1, circuitry of the holder (e.g. controller 260) establishes a data communication link with an aerosol delivery device (optionally when the aerosol delivery device is received by the holder). In a second step, S2, the holder selectively transmits user profile information from a memory element of the controller to the aerosol delivery device over the data communication link, and / or receives user profile information from the aerosol delivery device over the data communication link and stores the user profile information on the memory element.

Transmission of user data from a controller 22 of an aerosol delivery device to the controller 260 of the case (which may be referred to herein as a ‘backup’ procedure) may optionally be triggered / initiated every time the controller 260 detects that the aerosol delivery device 1 is received in the case. The controller 260 may detect the presence of the aerosol delivery device 1 according to approaches set out further herein, and transmit a signal to the controller 22 of the aerosol delivery device 1 to initiate a data communication link between controller 260 and controller 22. Thus when a user places an aerosol delivery device in the recess 225 of the case, the controller 260 of the case may receive a control input indicating that a USB-C connector comprised in the charging / data transfer interface 270 has a connection with a USB-C connector of an aerosol delivery device 1. The controller 260 then uses this input to initiate a transfer of user profile information from a memory element of the aerosol delivery device, to a memory element of the case (e.g. integrated in controller 260). In other embodiments, the transmission of user data may be triggered whilst the aerosol delivery device is not received by the holder (i.e. the aerosol delivery device is separate to / external to / outside the holder). In embodiments of the latter type, the data communications link comprises a wireless communications link as described further herein.

In any of the examples provided herein, the trigger of data transmission may automatically cause data transmission to be initiated, or may cause an indication to be given to a user (e.g. via a display of an aerosol delivery device, case, or other electronic device as described herein) that user profile data is available for transmission from the aerosol delivery device to the case, in response to which the user may confirm via appropriate user input (e.g. via a user input interface of an aerosol delivery device, case, or other electronic device as described herein) that they want the user profile data to be transmitted. This step may comprise enabling the user to select a subset of user profile data from the available user profile data for transmission from the aerosol delivery device to the case. For example, the user may select one or more of a plurality of user profiles as described further herein for transmission to the case.

In embodiments of the disclosure, there are a number of signals / triggers which may be used to initiate transmission of user profile information from an aerosol delivery device to a case, as described herein.

In some embodiments, a user may manually trigger a backup of user profile information using a user input interface on the aerosol delivery device or on the case. For example, the user may input a predefined control sequence on one or both of buttons 290 and 295 of the case (for example holding both buttons for at least 5 seconds) to indicate to controller 260 that the backup should be initiated.

A backup of user profile information may be triggered by a timer running on either of controller 22 of the aerosol delivery device 1 or controller 260 of the case. The timer may count elapsed time since the last backup of user profile information, and when the elapsed time reaches a predefined threshold (for example 6 hours, 12 hours, 24 hours, 2 days, a week, or any other period of time), the controller 260 may seek to initiate a data connection with the aerosol delivery device 1 (e.g. by establishing a data connection the next time the aerosol delivery device is detected in the case recess 225). The threshold may be set by a user. Alternatively or additionally, at the elapsing of the threshold, an indication (e.g. a visual, audible, and /or haptic indication) may be given to the user via the aerosol delivery device, the case, or another electronic device, that the user should place the aerosol delivery device in the case and initiate a backup.

A backup of user profile information may be triggered whenever a wired or wireless data connection is established between the case and the aerosol delivery device, according to approaches set out further herein.

A backup of user profile information may be triggered when an aerosol delivery device forms a data communication link with the case for the first time. For example, when an aerosol delivery device and a case form a data connection / data communication link, as described further herein, the case controller 260 may receive and store identifying information uniquely identifying the aerosol delivery device. Thus when an aerosol delivery device forms a data connection with the case, the case can compare the identifying information to its stored identifying information, and determine whether the aerosol delivery device has formed a data connection with the case before. When the case controller 260 determines an aerosol delivery device has formed a data connection with the case for the first time, it may trigger a backup of user profile information.

A backup of usage data may be dependent on the controller 260 of the case determining that the user profile information stored on the aerosol delivery device 1 has changed since the previous backup of user profile information from the aerosol delivery device to the case. For example, the controller 22 of the aerosol delivery device may set a change flag for the user profile information to ‘0’ when the user profile information is backed up to the case. When user profile information on the aerosol delivery device changes, the flag may be set to ‘1’ to indicate that a change has occurred since the last backup. This flag may be queried by the controller 260 of the case, and used to determine whether or not to perform a backup of user information. For example, when a backup is initiated via one of the approaches described further herein, the controller 260 may determine whether the change flag is ‘1’, and only backup the user profile information if this criterion is met. Where the user profile information comprises a plurality of user profiles, each user profile may have its own separate change flag, and only user profiles which have changed since the last backup may be transmitted from the aerosol delivery device to the case.

In some embodiments, when user profile information is received by the case, this information is forwarded to a further electronic device in a wider aerosol delivery ecosystem. For example, user profile information may be transmitted to a smartphone 100 for storage and retrieval at a later stage and / or for viewing by a user on an APP. User profile information may be transmitted to a server 1000 for storage and retrieval at a later stage. In some embodiments where user profile information is forwarded from the case to a further electronic device, the user profile information on the case can be deleted from memory or overwritten once it has been transmitted to the further electronic device for storage. This may be advantageous in allowed the user profile information to be received by the case, which may be in regular data communication with the aerosol delivery device, but stored on a further device with a larger storage capacity (e.g. a cloud storage server 1000), and / or which is less prone to loss than the case.

In some embodiments of the present disclosure, the case is configured to transmit user profile information to the aerosol delivery device via the communications interface when a aerosol delivery device is received in the case. This transmission may be broadly triggered in a similar range of ways to the those described further herein for triggering the backup of user profile information from an aerosol delivery device to a case.

In any of the below examples, the trigger of data transmission may automatically cause data transmission to be initiated, or may cause an indication to be given to a user (e.g. via a display of an aerosol delivery device, case, or other electronic device as described herein) that user profile data is available for transmission from the case to the aerosol delivery device, in response to which the user may confirm via appropriate user input (e.g. via a user input interface of an aerosol delivery device, case, or other electronic device as described herein) that they want the user profile data to be transmitted. This step may comprise enabling the user to select a subset of user profile data from the available user profile data for transmission from the case to the aerosol delivery device. For example, the user may select one or more of a plurality of user profiles as described further herein for transmission to the aerosol delivery device.

Thus in embodiments of the disclosure, transmission of user data from a controller 260 of the case to a controller 22 of an aerosol delivery device (which may be referred to herein as a ‘download’ procedure) may be triggered / initiated every time the controller 260 detects that the aerosol delivery device 1 is received in the case. The controller 260 may detect the presence of the aerosol delivery device 1 according to approaches set out further herein, and transmit a signal to the controller 22 of the aerosol delivery device 1 to initiate a data communication link between controller 260 and controller 22. Thus when a user places an aerosol delivery device in the recess 225 of the case, the controller 260 of the case may receive a control input indicating that a USB-C connector comprised in the charging / data transfer interface 270 has a connection with a USB-C connector of an aerosol delivery device 1. The controller 260 then uses this input to initiate a transfer of user profile information from a memory element of the case, to a memory element of the aerosol delivery device (e.g. integrated in controller 22).

In other embodiments, any one or more of the following triggers may be used to initiate transmission of user profile information from the case to an aerosol delivery device.

A user may manually trigger a download of user profile information using a user input interface on the aerosol delivery device or on the case. For example, the user may input a predefined control sequence on one or both of buttons 290 and 295 of the case (for example holding both buttons for at least 5 seconds) to indicate to controller 260 that the download should be initiated.

A download of user profile information may be triggered by a timer running on either of controller 22 of the aerosol delivery device 1 or controller 260 of the case. The timer may count elapsed time since the last download of user profile information, and when the elapsed time reaches a predefined threshold (for example 6 hours, 12 hours, 24 hours, 2 days, a week, or any other period of time), the controller 260 may seek to initiate a data connection with the aerosol delivery device 1 (e.g. by establishing a data connection the next time the aerosol delivery device is detected in the case recess 225). The threshold may be set by a user. Alternatively or additionally, at the elapsing of the threshold, an indication (e.g. a visual, audible, and /or haptic indication) may be given to the user via the aerosol delivery device, the case, or another electronic device, that the user should place the aerosol delivery device in the case and initiate a download (e.g. via manual triggering as described herein).

A download of user profile information may be triggered whenever a wired or wireless data connection is established between the case and the aerosol delivery device, according to approaches set out further herein.

A download of user profile information may be triggered when an aerosol delivery device forms a data communication link with the case for the first time. For example, when an aerosol delivery device and a case form a data connection / data communication link, as described further herein, the case controller 260 may receive and store identifying information uniquely identifying the aerosol delivery device. Thus when an aerosol delivery device forms a data connection with the case, the case can compare the identifying information to its stored identifying information, and determine whether the aerosol delivery device has formed a data connection with the case before. When the case controller 260 determines an aerosol delivery device has formed a data connection with the case for the first time, it may trigger a download of user profile information.

A download of usage data may be dependent on the controller 260 of the case determining that the user profile information stored on the case has changed since the previous download of user profile information from the aerosol delivery device to the case. For example, the controller 260 of the case may set a change flag for user profile information stored on the case to ‘0’ when the user profile information is first stored on the case (e.g. backed up from an aerosol delivery device). When user profile information on the aerosol delivery device changes (for example because a user edits the user profile information on the case using a user input interface on the case or on a further electronic device with a data connection to the case), the flag may be set to ‘1’ to indicate that a change has occurred since the last backup. This flag may be used to determine whether or not to perform a download of user information to an aerosol delivery device. For example, when a download is initiated via one of the approaches described further herein, the controller 260 may determine whether the change flag is ‘1’, and only download the user profile information to the aerosol delivery device if this criterion is met. Where the user profile information comprises a plurality of user profiles, each user profile may have its own separate change flag, and only user profiles which have changed since the last backup may be transmitted from the case to the aerosol delivery device.

In some embodiments, user profile information to be transmitted to an aerosol delivery device by a case is received from an external electronic device in a wider aerosol delivery ecosystem. For example, user profile information may be transmitted from a smartphone 100 to the case, for download to the aerosol delivery device by the case. The user profile information may comprise one or more user profiles stored on or set up via an APP on the smartphone (e.g. comprising power parameters and other control parameters as described herein), or user profiles stored on a server 1000. The user profile information on an external device may previously have been backed up to the external device from an aerosol delivery device as described further herein. Thus a case may receive user profile information from an external electronic device, and store it for download to an aerosol delivery device the next time a data connection is established between the case and the aerosol delivery device. In some embodiments, the user profile information on the case can be deleted from memory or overwritten once it has been transmitted to the aerosol delivery device.

It will be appreciated that though the functionality of establishing a data communication link and determining to initiate transmission of user data between the case controller 260 and the controller 22 of the aerosol delivery device 1 has been described as being carried out by the case controller 260, it will be appreciated that this functionality may alternatively be carried out by the controller 22 of the aerosol delivery device.

Moreover, the functionality of the present disclosure has been described in detail in relation to a case 200 which is configured to receive user profile information from an aerosol delivery device 1, and store this information locally or remotely, such that the user profile information or a selected subset may be transferred back to the same or a different aerosol delivery device 1 from the case 200. A case for storage and / or charging (appreciating a case may not necessarily provide charging functionality) may be an advantageous electronic device to use for storing user data (e.g. user profile information) because of the frequency with which such a device may be able to establish a data transfer connection with an aerosol delivery device. For example, a user may generally carry their aerosol delivery device in a case, and / or carry their case and aerosol delivery device on their person, such that even if the aerosol delivery device is not in the case, it will be in wireless data transfer range of the case (e.g. within range to form a paired Bluetooth connection with the case). However, it will be appreciated that another electronic device may provide the functions described with respect to case 200. For example, any electronic device having a controller, memory, a wired or wireless interface for data communication with an aerosol delivery device, and a user input interface, may be substituted for the case 200 in the above disclosure. This functionality may be provided, for example, by a smartphone 100, a dock 200 (e.g. a recharging case or home refill and/or charging station), a personal computer (PC) 300, a wearable device 400, or a server 1000, as shown in FIG. 2, and described further herein. Advantageously, the external electronic device comprises a holder which is configured to physically receive all or part of an aerosol delivery device. A holder may thus comprise a case as described herein, or a charging station such as a tabletop charging dock, or a refill station which is configured to refill an aerosol delivery device and / or cartridges of an aerosol delivery device with aerosol generating material, or any other electronic device known to the skilled person which may be used to hold, retain, carry, or store an aerosol delivery device. A holder may be configured with at least a controller 260 and charging / data transfer interface 270 as described herein in relation to a case 200, having the functionality as described for these elements further herein.

Thus there has been described a holder for an aerosol delivery device, the holder comprising: an aerosol delivery device receiving region configured to receive at least a portion of an aerosol delivery device; a controller configured to establish a data communication link with an aerosol delivery device; wherein the controller comprises a memory element configured to store user profile information for an aerosol delivery device; and wherein the controller is configured to selectively transmit user profile information from the memory element to the aerosol delivery device over the data communication link, and / or to receive user profile information from the aerosol delivery device over the data communication link and store the user profile information on the memory element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future. The delivery system described herein can be implemented as a combustible aerosol delivery device, a non-combustible aerosol delivery device or an aerosol-free delivery system.

1. A holder for an aerosol delivery device, the holder comprising:
an aerosol delivery device receiving region configured to receive at least a portion of an aerosol delivery device;
a controller configured to establish a data communication link with an aerosol delivery device;
wherein the controller comprises a memory element configured to store user profile information for an aerosol delivery device; and
wherein the controller is configured to selectively transmit user profile information from the memory element to the aerosol delivery device over the data communication link, and / or to receive user profile information from the aerosol delivery device over the data communication link and store the user profile information on the memory element.

2. The holder of claim 1, wherein the user profile information comprises control data for modifying operation of the aerosol delivery device, comprising information about one or more parameters for controlling one or more aspects of the operation of the aerosol provision device.

3. The holder of any of claim 1, wherein the user profile information comprises usage data established, wherein the usage data is established based on monitoring the interaction of a user with the aerosol delivery device, and / or comprises information about the identity of a user of the aerosol delivery device.

4. The holder of claim 1, wherein the user profile information comprises a plurality of user profiles comprising different user profile information.

5. The holder of claim 1, wherein the controller is configured to transmit user profile information to the aerosol delivery device over the data communication link in response to receiving a signal indicating a transmission of user profile information should be initiated.

6. The holder of claim 1, wherein the controller is configured to receive user profile information from the aerosol delivery device over the data communication link in response to receiving a signal indicating a reception of user profile information should be initiated.

7. The holder of claim 5, wherein the signal comprises a manual user input to a user interface.

8. The holder of claim 5, wherein the signal is received by the controller from an external electronic device over a data communication link.

9. The holder of claim 5, wherein the signal comprises an indication a data connection has been established between the controller and the aerosol delivery device.

10. The holder of claim 5, wherein the signal comprises an indication an aerosol delivery device has been received by the holder.

11. The holder of claim 5, wherein the signal comprises an indication that user profile information stored on the memory element of the controller has changed since a previous transmission of user profile information to the aerosol delivery device.

12. The holder of claim 5, wherein the signal comprises a determination that a predefined amount of time has elapsed since a previous instance on which user profile information was transmitted to the aerosol delivery device over the data communication link.

13. The holder of claim 5, wherein the controller is configured to indicate to a user that user profile information is available for transmission to the aerosol delivery device over the data communication link, and transmit the user profile information to the aerosol delivery device over the data communication link if a signal comprising a predefined user input is received in response to providing the indication.

14. The holder of claim 1, wherein the controller is configured to transmit to the aerosol delivery device a subset of a total amount of user profile information available for transmission on the memory element.

15. The holder of claim 6, wherein the signal comprises a signal received from an aerosol delivery device indicating that user profile information stored on the aerosol delivery device has changed since a previous reception of user profile information from the same aerosol delivery device over the data communication link.

16. The holder of claim 6, wherein the signal comprises a determination that a predefined amount of time has elapsed since a previous instance on which user profile information was received from the aerosol delivery device over the data communication link.

17. The holder of claim 6, wherein the controller is configured to indicate to a user that user profile information is available for reception from an aerosol delivery device, and receive the user profile information from the aerosol delivery device over the data communication link if a signal comprising a predefined user input is received in response to providing the indication.

18. The holder of claim 1, wherein the controller is configured to receive from an aerosol delivery device a subset of a total amount of user profile information available for reception from the aerosol delivery device.

19. The holder of claim 11, wherein the subset of the user profile information comprises one or more profiles from a plurality of user profiles available for transmission or reception.

20. The holder of claim 1, wherein the controller is configured to modify user profile information stored on the memory element in response to receiving a signal indicating the user profile information should be modified.

21. The holder of claim 20, wherein the signal comprises an input received via a user input interface, and the modification of user profile information comprises modifying at least one control parameter comprised in the user profile information.

22. The holder of claim 1, wherein the controller is configured to establish a data communication link with an aerosol delivery device when the aerosol delivery device is received by the holder.

23. A method of operating a holder for an aerosol delivery device, the holder comprising a controller, wherein the controller is configured to perform the steps of:
establishing a data communication link with an aerosol delivery device;
selectively transmitting user profile information from a memory element of the controller to the aerosol delivery device over the data communication link, and / or receiving user profile information from the aerosol delivery device over the data communication link and storing the user profile information on the memory element.

24. A computer readable storage medium comprising instructions which, when executed by a processor, performs the method of claim 23.

25. Holder means for an aerosol delivery device, the holder means comprising:
aerosol delivery device receiving means configured to receive at least a portion of an aerosol delivery device;
controller means configured to establish a data communication link with an aerosol delivery device;
wherein the controller means comprises memory element means configured to store user profile information for an aerosol delivery device; and
wherein the controller means is configured to selectively transmit user profile information from the memory element means to the aerosol delivery device over the data communication link, and / or to receive user profile information from the aerosol delivery device over the data communication link and store the user profile information on the memory element.

26. An aerosol delivery device, the aerosol delivery device comprising:
a region configured to be received by a holder;
a controller configured to establish a data communication link with the holder;
wherein the controller comprises a memory element configured to store user profile information for the aerosol delivery device; and
wherein the controller is configured to selectively transmit user profile information from the memory element to the holder over the data communication link, and / or to receive user profile information from the holder over the data communication link and store the user profile information on the memory element.

27. The holder of claim 6, wherein the signal comprises a manual user input to a user interface.

28. The holder of claim 6, wherein the signal is received by the controller from an external electronic device over a data communication link.

29. The holder of claim 6, wherein the signal comprises an indication a data connection has been established between the controller and the aerosol delivery device.

30. The holder of claim 6, wherein the signal comprises an indication an aerosol delivery device has been received by the holder.

31. The holder of claim 12, wherein the subset of the user profile information comprises one or more profiles from a plurality of user profiles available for transmission or reception.

32. The holder of claim 13, wherein the subset of the user profile information comprises one or more profiles from a plurality of user profiles available for transmission or reception.

33. The holder of claim 14, wherein the subset of the user profile information comprises one or more profiles from a plurality of user profiles available for transmission or reception.

34. The holder of claim 15, wherein the subset of the user profile information comprises one or more profiles from a plurality of user profiles available for transmission or reception.

35. The holder of claim 16, wherein the subset of the user profile information comprises one or more profiles from a plurality of user profiles available for transmission or reception.

36. The holder of claim 17, wherein the subset of the user profile information comprises one or more profiles from a plurality of user profiles available for transmission or reception.

37. The holder of claim 18, wherein the subset of the user profile information comprises one or more profiles from a plurality of user profiles available for transmission or reception.
